(19) United States
(12) Patent Application Publication
(10) Pub. No.: US 2017/0285448 A1
(43) Pub. Date: Oct. 5, 2017

(54) HOLOGRAM PROJECTOR

(71) Applicant: Freddie Lee Figgers, Florida, FL (US)

(72) Inventor: Freddie Lee Figgers, Florida, FL (US)

(73) Assignee: Freddie Lee Figgers, Florida, FL (US)

(21) Appl. No.: 15/626,121

(22) Filed: Jun. 17, 2017

Related U.S. Application Data
(60) Provisional application No. 62/455,685, filed on Feb. 7, 2017.

(51) Int. Cl. G03B 21/00; G03B 33/10; H04N 9/31; G03B 21/14

(52) U.S. Cl. CPC G03B 21/006; G03B 21/145; G03B 33/10; H04N 9/3173

(57) ABSTRACT

The present invention describes a hologram projector that is used to project three dimensional high definition images on the screen using various electronic devices. The hologram projector can provide an upright display that is comfortable to view while allowing the electronic device to lay flat, by incorporating a completely or partially reflective material along with the hologram projector. The projector works on the Liquid crystal on silicon (LCOS) technology for projecting the images. The hologram projector can be connected to electronic devices like smartphones, laptop, personal computers tablets, media players etc. either through wired or wireless connections. The media file has to be loaded in the electronic device and the electronic device has to be connected to the hologram projector through wireless or wired connection and the hologram can be displayed on the high definition screen up to 150 inch.

### FIELD OF THE INVENTION

The present invention generally relates to portable electronic devices. More specifically to the Liquid Crystal on Silicon (LCoS) projectors that offer a screen for displaying the contents of a display of any electronic device.

### BACKGROUND OF THE INVENTION

Hologram projectors which are used to display the larger images have become increasingly popular for various applications in recent days. The main advantage of holograms compared to other display techniques is the capability of displaying three dimensional and moving scenes. Currently holograms have been used to display the three dimensional images on the billboards and other projectors which are used for office purposes for delivering presentations.

The main problem which occurs dining hologram projection is that the images that are projected on the projector are not sharp enough to see them clearly. If the image is projected on the screen which is of smaller size, the image looks more clear and sharp and the details are highly visible. As the screen size gets larger, the projected image do not remain sharp and it looks scattered. In order to achieve, sharper images on larger screens, the projector has to be of higher resolution and made of advanced technology.

This creates the need for a hologram projector making use of advanced technology, which can be used along with any electronic devices at any time or at an place.

### OBJECTIVES OF THE INVENTION

The primary objective of the present invention, is to provide a hologram projector that is equipped with Liquid Crystal on Silicon (LCoS) technology.

Another objective of the present invention is to provide a hologram projector that is portable in nature.

Another objective of the present invention is to provide a hologram projector that, can project holograms up to 150 inch on a high definition screen.

Another objective of the present invention is to provide a hologram, projector that is compatible with all types of electronic devices like smartphone, tablets, laptops, personal computers, or any other devices.

Another objective of the present invention is to provide a hologram projector which is compatible with all kinds of electronic devices that can video, audio, pictures or presentations.

Another objective of the present invention is to provide a hologram projector that can work with the help of wired connection or wireless connection.

### SUMMARY OF THE INVENTION

The present invention describes a hologram projector that is used to project the three dimensional high definition images on the screen using various electronic devices. The present invention provides an accessory to display the images from the electronic device on to the large screen. The hologram projector can provide an upright display that is comfortable to view while allowing the electronic device to lay flat, for example, on a lap or desk. This can be achieved by incorporating a completely or partially reflective material along with the hologram projector.

The present invention works on the Liquid crystal on silicon (LCoS or LCOS) technology for projecting the images into the dedicated space with greater resolution. LCoS is a small sized reflective active-matrix liquid-crystal display or also known as micro-display, uses a liquid crystal layer on top of a silicon backplane. This can also be known as spatial light modulator.

LCoS is a reflective technology that uses liquid crystals. In LCOS, liquid crystals are applied to a reflective mirror substrate. As the liquid crystals open and close, the light is either reflected from the mirror below, or blocked. This modulates the light and creates the image. LCoS based projectors typically use three. LCoS chips, one each to modulate light in the red, green, and blue channels. LCoS projectors deliver the red, green, and blue components of the light to the screen simultaneously.

LCOS technology was initially developed for projection televisions but is also being used for various activities including high definition displays, wavelength selective switching, structured illumination, near-eye displays and optical pulse shaping etc.

The present invention can be effortless used to display the forms of media like audio, video, pictures of presentations. The projector can be used to provide a perfect environment and set-up for watching movies, reading, or viewing photos, songs, movies, presentations etc.

The present invention which describes the hologram projector can be connected to electronic devices either through wired or wireless connections as the projector is compatible with both the ways. The present invention is also compatible with all kinds of the electronic devices like smartphones, laptop, personal computers, tablets, media players etc.

The user has to load the media file which has to be viewed through the projector in any of the electronic devices like smartphone, PC, laptop etc., and has to connect the respective electronic device having the media file to the hologram projector. The connection can be made wirelessly or wired connection. Once both the devices gets connected with each other, the hologram can be displayed on the high definition screen which can span up to 150 inch. The present invention provides sharp vivid colour images at any time and at any place.

### BRIEF DESCRIPTION OF DRAWINGS

FIG. 1 describes the LCoS based hologram projector used to display high definition images on larger screens.

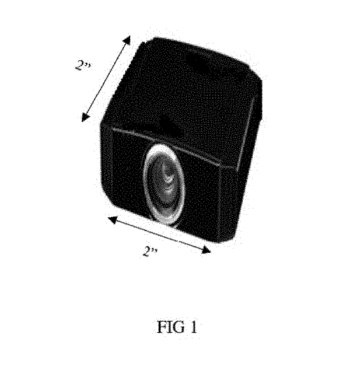

### DETAILED DESCRIPTION OF THE INVENTION

The present invention describes a device that is used to project clear and sharper images on the screen. The invention is a hologram projector that is used to project the three dimensional high definition images on the screen using various types of electronic devices.

The present invention works on the Liquid crystal on silicon (LCoS) technology for projecting the images into the space with greater resolution. The hologram projector which uses the LCOS technology, can provide an upright display that is comfortable to view. The electronic device which is coupled along with the hologram projector can be positioned in any way like on a lap or desk or in hand. The position of the electronic device does not hinder the performance of the projector as LCoS technology is used in the same.

The hologram projector described in the present invention uses a reflective technology wherein the liquid crystals are applied to a reflective mirror substrate, which opens and closes, making the light to reflect from the mirror below, or getting blocked. The opening and closing of the liquid crystals modulates the light and creates the image which is projected on the larger screens.

The hologram projector which is described in the present invention is a portable, two inch cube shaped hologram projector with a high capacity to project any media file on the screen that can span up to 150 inch. The media displayed will be in the form of a high definition (HD) format characterizing sharp and cleaner images with greater resolution. The colour images which are projected on the screen remain intact and do not appear scattered.

The hologram projector can be connected to all kinds of electronic devices like smartphones, laptop, personal computers, tablets, media players etc. either through a wired connection or a wireless connections. The hologram projector is compatible with both types of connection which eases the work of the user.

In order to project a larger and high definition image present in the electronic device on to the larger screen, the user has to load the media file, to any of the electronic devices including smartphone, personal computer, laptop, desktop, tablet, media player etc., After loading the media file to one of the electronic devices, the user has to connect the respective electronic device containing the media file to the hologram projector. The connection can be made wirelessly by providing a password or direct connection, or through wired connection wherein a wire is provided which connects both the electronic device and the hologram projector. Once both the devices gets connected with each other, the content present in the media file is displayed on the high definition screen which can span up to 150 inch. The present invention provides sharp vivid colour images at any time and at any place.

There are several advantages of present invention over the existing products available in the market. The main advantage of the present invention is that, it uses LCoS technology which is of very high resolution.

Another advantage of the present invention is that, the hologram projector is portable in nature and it can be carded by the user on the go as it fits easily in the bag.

Yet another advantage of the present invention is that, the hologram projector is compatible with both wired and wireless connections which makes the handling easier for the users.

Yet another advantage of the present invention is that, the hologram projectors can he connected to any type of electronic devices starting from smartphones to laptops, tablets, personal computers, media players, etc.,

The present invention also have a few disadvantages. One of the main disadvantages of the present invention includes higher cost than most LCD and DLP products.

1. A hologram projecting device comprising of a light source, Liquid crystal on silicon (LCoS) chips, connecting means and a control system, that can display the image on the display screen provided.

2. A hologram projecting device as claimed in claim 1, wherein the light source provides light input to the projector for creating the image.

3. A hologram protecting device a claimed in claim 1, wherein the LCoS chips comprises of plurality of pixels that reflects the light which falls on it to create the image and projects it on the display screen.

4. A hologram projecting device as claimed in claim 1, wherein the connecting means refers to either wireless connection or wired connection which is used to create connection between the hologram projector and the electronic device.

5. A hologram projecting device as churned in claim 1, wherein the control system controls the operation of the liquid crystal chips present in the projector.

6. A hologram projecting device as claimed in claim 1, wherein the display screen can be up to 150 inch which displays the magnified high definition image form the electronic device.

7. A hologram projecting device as claimed in claim 1, wherein the projector uses LCoS technology

8. A hologram projecting device as claimed in claim 1, wherein the projector is portable in nature and can be carried on the go.

9. A hologram projecting device as claimed in claim 1, wherein the projector is two inch cube shaped device which makes it highly compact.
